(19) United States
(12) Patent Application Publication
(10) Pub. No.: US 2024/0404246 A1
(43) Pub. Date: Dec. 5, 2024

(54) IMAGE PROCESSING APPARATUS AND CONTROL METHOD FOR SAME

(71) Applicant: CANON KABUSHIKI KAISHA, Tokyo (JP)

(72) Inventor: Shogo KINUGAWA, Kanagawa (JP)

(21) Appl. No.: 18/675,232

(22) Filed: May 28, 2024

(30) Foreign Application Priority Data
May 29, 2023 (JP) 2023-088069

(51) Int. Cl. G06V 10/74; G06T 5/40; G06V 10/44

(52) U.S. Cl. CPC G06V 10/761; G06T 5/40; G06V 10/44

(57) ABSTRACT

An image processing apparatus: obtains image features of a collation target person; obtains a plurality of registered image features corresponding to a plurality of persons respectively associated with correct answer values of a plurality of attributes; calculates a similarity between the image features and each of the plurality of registered image features; determines to which of the plurality of persons the collation target person corresponds; derives an attribute-wise determination accuracy included in the plurality of attributes, based on a history; and compares, for each attribute, a first determination accuracy based on first image features and a second determination accuracy based on second image features, and detect an attribute exhibiting an accuracy difference equal to or larger than a predetermined threshold value.

### BACKGROUND OF THE INVENTION

### Field of the Invention

The present invention relates to an image collation process.

### Description of the Related Art

There is known a technique referred to as face collation that compares an input face image with a plurality of preliminarily registered face images to determine which of the plurality of preliminarily registered faces matches the input face image. Generally, an identification unit of face collation is trained using a machine learning method. However, the method of machine learning may exhibit a lower accuracy in an actual environment than an accuracy assumed at the time of development. One of the causes may be that the statistical properties assumed for the input data do not match those of the data during actual operation, or that the initially matched properties of both data have deviated for some reason (referred to as data drift). Japanese Patent Laid-Open No. 2013-74461 (Patent Document 1) discloses a method of determining, in face collation, whether or not to update registered information, based on a temporal change in similarity between a collation target person and a registered person.

Meanwhile, there has arisen a problem of accuracy imbalance in attribute-wise (race, gender, etc.) face collation. Insufficient collation accuracy for a specific attribute may cause disadvantage for some users and may lead to problems of race and the like. In order to reduce such a risk, it is important to check whether or not the attribute-wise accuracy assumed at the time of development is maintained at the time of system installation. Patent Document 1 described above monitors the temporal change in similarity for each individual and therefore cannot detect degradation of attribute-wise accuracy in the system installation environment.

### SUMMARY OF THE INVENTION

According to one aspect of the present invention, an image processing apparatus comprising one or more memories storing instructions and one or more processors that execute the instructions to: obtain image features of a collation target person; obtain a plurality of registered image features corresponding to a plurality of persons respectively associated with correct answer values of a plurality of attributes; calculate a similarity between the image features and each of the plurality of registered image features; determine to which of the plurality of persons the collation target person corresponds, based on the calculated similarity; derive an attribute-wise determination accuracy included in the plurality of attributes, based on a history in which the calculated similarity and the result of determination are associated with each other; and compare, for each attribute, a first determination accuracy derived based on first image features based on an image captured under a first image capturing environment and a second determination accuracy derived based on second image features based on an image captured under a second image capturing environment, and detect an attribute exhibiting an accuracy difference equal to or larger than a predetermined threshold value.

According to another aspect of the present invention, an image processing apparatus comprising one or more memories storing instructions and one or more processors that execute the instructions to: obtain image features of a collation target person; estimate a plurality of attributes of the collation target person based on an image of the collation target person; obtain a plurality of registered image features corresponding to a plurality of persons respectively associated with correct answer values of a plurality of attributes; calculate a similarity between the image features and each of the plurality of registered image features; determine to which of the plurality of persons the collation target person corresponds, based on the calculated similarity; and compare a first attribute histogram generated based on the history of the estimated plurality of attributes and a second attribute histogram generated based on the history of the plurality of attributes corresponding to the determined person for each attribute, and detect an attribute exhibiting an accuracy difference equal to or larger than a predetermined threshold value.

According to still another aspect of the present invention, an image processing apparatus comprising one or more memories storing instructions and one or more processors that execute the instructions to: obtain image features of a collation target person; estimate a plurality of attributes of the collation target person based on an image of the collation target person; obtain a plurality of registered image features corresponding to a plurality of persons respectively associated with correct answer values of a plurality of attributes; calculate a similarity between the image features and each of the plurality of registered image features; and determine to which of the plurality of persons the collation target person corresponds, based on the calculated similarity; generate a first ratio distribution obtained by dividing a value of each bin of a first attribute histogram generated based on a history of a plurality of attributes estimated based on an image captured under a first image capturing environment by a value of each bin of a second attribute histogram generated based on a history of a plurality of attributes corresponding to a person determined based on image features of the image captured under the first image capturing environment; generate a second ratio distribution obtained by dividing a value of each bin of a third attribute histogram generated based on the history of the plurality of attributes estimated based on the image captured under the second image capturing environment by a value of each bin of a fourth attribute histogram generated based on the history of the plurality of attributes corresponding to the person determined based on the image features of the image captured under the second image capturing environment; and compare the first ratio distribution and the second ratio distribution for each attribute and detect an attribute exhibiting an accuracy difference equal to or larger than a predetermined threshold.

The present invention allows for detecting a change in attribute-wise accuracy in a collation process.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates an overall configuration of a collation system.

FIG. 2 illustrates a hardware configuration of an information processing apparatus.

FIG. 3 illustrates a functional configuration of the information processing apparatus.

FIG. 4 is a flowchart of a registration process.

FIG. 5 illustrates an example of person information stored in the registration process.

FIG. 6 is a flowchart of the collation process.

FIG. 7 illustrates an example of attribute-wise similarity information.

FIG. 8 is a flowchart of a state measurement process.

FIG. 9 illustrates an example of attribute-wise similarity information according to a modification.

FIG. 10 illustrates an example of a functional configuration of the information processing apparatus (second embodiment).

FIG. 11 is a flowchart of the collation process (second embodiment).

FIG. 12 is an explanatory diagram of collecting attribute histograms.

FIG. 13 is a flowchart of the state measurement process (second embodiment).

FIG. 14 is a flowchart of the collation process (third embodiment).

FIG. 15 is a flowchart of the state measurement process (third embodiment).

FIG. 16 illustrates a functional configuration of the information processing apparatus (fourth embodiment).

FIG. 17 is a flowchart of a learning process.

FIG. 18 is a flowchart of the state measurement process (fourth embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

A first embodiment of an image processing apparatus according to the present invention will be described below taking as an example an information processing apparatus in a collation system that collates a face of a person included in a captured image. Specifically, there will be described an embodiment that obtains, at the time of face collation, attributes corresponding to a collation target person from a registration database having attributes preliminarily registered therein, aggregates the similarity for each attribute, and detects degradation of attribute-wise accuracy.

### Attribute Category and Attribute

“Race”, “gender” or the like are referred to as attribute categories, and a classification (value) in each attribute category is referred to as an attribute. In an attribute category “race”, for example, an attribute is supposed to take a value such as “White” or “Black”.

In the following description, it is assumed that attribute categories and attributes belonging to respective attribute categories are preliminarily defined as follows. Describing an attribute category in the form of attribute category=[attribute 1, attribute 2, attribute N] results in the following:
Gender=[men, women]
Race=[White, Black, Asian]
   (However, race may be further divided into finer sub-segments for each region.)
Age=[under-ten, ten, eleven, twelve and teens, 20s, 30s, 40s, 50s, 60s or above]
   (However, there may be a broader classification of ages such as senior, child, and adolescent.)
Facial direction=[front, profile]
Facial expression=[smile, anger, expressionless]
Type of beard=[goatee, mustache]
Hair style=[long, short]
Hair color=[black, brown, blonde]
Blur=[strong blur, weak blur]
Noise=[strong noise, weak noise]

Here, the attribute categories and attributes in respective attribute categories described above are examples, and other attribute categories or attributes may be used.

In the following description, there will be described an example of detecting attribute-wise accuracy degradation for attribute categories: “race”, “gender”, and “age”. However, it is possible to detect accuracy degradation also in other attribute categories by a similar process.

### System Configuration and Apparatus Configuration

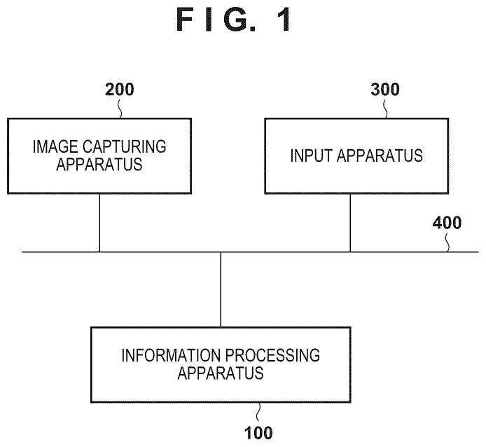

FIG. 1 illustrates an overall configuration of the collation system according to the first embodiment. The collation system includes an information processing apparatus 100, an image capturing apparatus 200, and an input apparatus 300, which are interconnected by a network 400. The information processing apparatus 100, the image capturing apparatus 200, and the input apparatus 300 may be configured as a plurality of separate apparatuses or a single apparatus (housing).

The information processing apparatus 100 is an apparatus that performs face collation and measurement of an attribute-wise accuracy degradation state (also simply referred to as state measurement), which will be described below. The information processing apparatus 100 is an information processing apparatus such as, for example, a personal computer having programs installed therein for realizing functions of the processes described below.

The image capturing apparatus 200 is an apparatus that captures images. The image capturing apparatus 200 transmits image data based on captured images to the information processing apparatus 100 via the network 400. Note that there may be one or more image capturing apparatuses 200 in the collation system.

The input apparatus 300 is an acceptance apparatus that accepts input of identification (ID) card collation information used for ID card collation and individual identification information (identification information) for identifying a registered person used for one-to-one collation. For example, it is a card reader or an optical scanner that accepts an operation performed by a person to be collated (collation target person) and accepts an input of the aforementioned information. The input apparatus 300 transmits the aforementioned input information to the information processing apparatus 100 via the network 400.

The network 400 includes a plurality of routers, switches, cables or the like that comply with a communication standard such as ETHERNET (registered trademark), for example. Here, the network 400 is, for example, a wired local area network (LAN), a wireless LAN, a wide area network (WAN) such as the Internet, or the like.

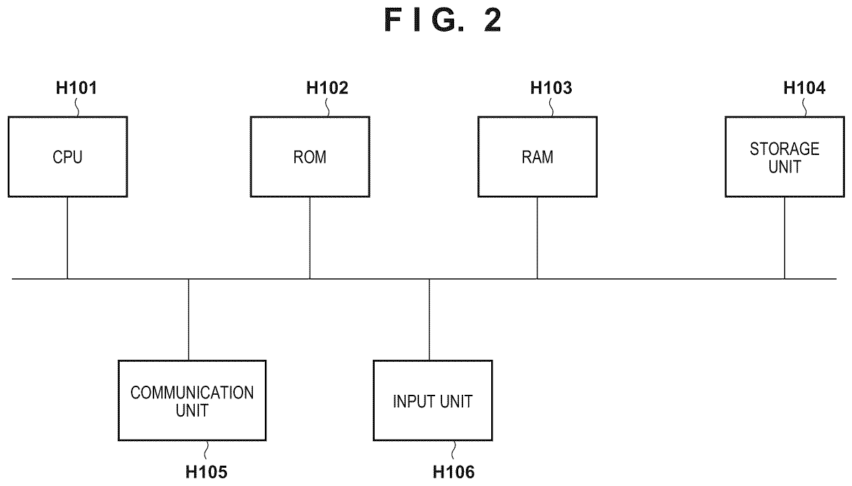

FIG. 2 illustrates a hardware configuration of the information processing apparatus 100. A CPU H101 controls the entire apparatus by executing programs stored in a ROM H102. A RAM H103 temporarily stores various data from respective components. In addition, the RAM H103 deploys a program to be executable by the CPU H101. A storage unit H104 stores registration information (attribute, feature amount, ID card collation information, etc.), similarity information for detecting degradation of the attribute-wise accuracy, or the like. A medium such as a Hard Disk Drive (HDD), a flash memory, various optical media may be used as the storage unit 104. In addition, the storage unit 104 can communicate with the image capturing apparatus 200 and other apparatuses via the communication unit H105. An input unit H106 is an input apparatus such as a keyboard. It is used when registering a person to be registered for inputting information such as an attribute of the person to be registered.

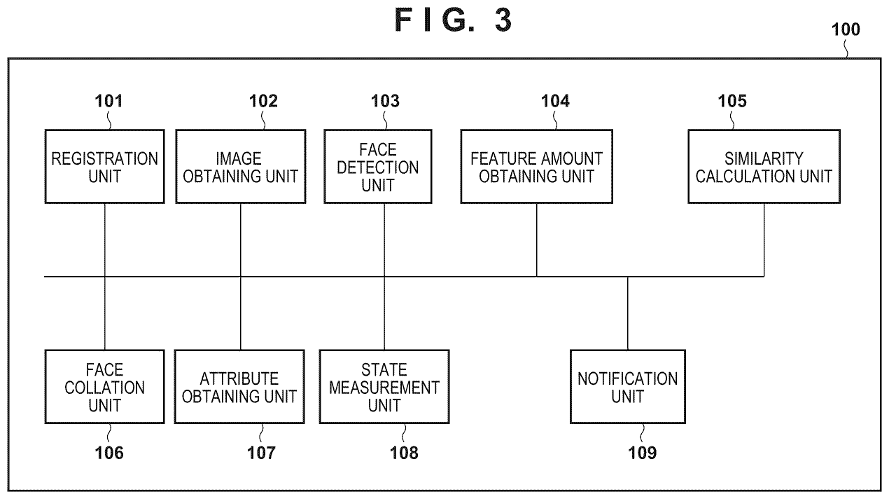

FIG. 3 illustrates a functional configuration of the information processing apparatus 100. The information processing apparatus 100 includes a registration unit 101, an image obtaining unit 102, a face detection unit 103, a feature amount obtaining unit 104, a similarity calculation unit 105, a face collation unit 106, an attribute obtaining unit 107, a state measurement unit 108, and a notification unit 109.

The registration unit 101 registers the face feature amount, the attribute, and the ID card collation information in the registration database 500 of the storage unit H104 in association with the person to be registered. In the present embodiment, correct answer values of race, gender, and age of a person to be registered are registered as attributes. The information registered in association with the person to be registered as described above will be referred to as registration information in the following description. In addition, the face feature amount registered will be referred to as a registered image feature amount.

The image obtaining unit 102 obtains a captured image from the image capturing apparatus 200 via the network 400. The collation system may also be configured to obtain an image prepared by the user. The face detection unit 103 detects a face of a person from the image obtained by the image obtaining unit 102. Any known method can be used to detect the face.

The feature amount obtaining unit 104 obtains feature amounts (image features) required for face collation when identifying an individual from a face region image detected by the face detection unit 103. Any known method can be used as the process for obtaining, from an image, a feature amount required for face collation.

The similarity calculation unit 105 calculates a similarity between feature amounts. The similarity may be a numerical value obtained by multiplying the Euclidean distance between feature amounts by −1, or a known method such as, for example, the cosine similarity may be used. However, it is assumed in the following description that the similarity is normalized to a value in a range from 0 to 1. The similarity indicates that a larger value (closer to 1) represents a higher similarity, and a smaller value (closer to 0) represents a lower similarity.

The face collation unit 106 determines whether or not the collation target person exists among registered persons, based on the similarity calculated by the similarity calculation unit 105. When the similarity between two persons is equal to or higher than a specific threshold value, the face collation unit 106 determines that the feature amounts are similar and therefore the persons are the same. The attribute obtaining unit 107 obtains the attribute of the registered person identified by the face collation unit 106 from the registration database 500 of the storage unit H104. In the present embodiment, attributes related to race, age, and gender are obtained as described above.

The state measurement unit 108 measures the attribute-wise accuracy degradation state. Details of the process will be described below. The notification unit 109 notifies an installation personnel or the like that accuracy degradation has been detected.

### Apparatus Operation

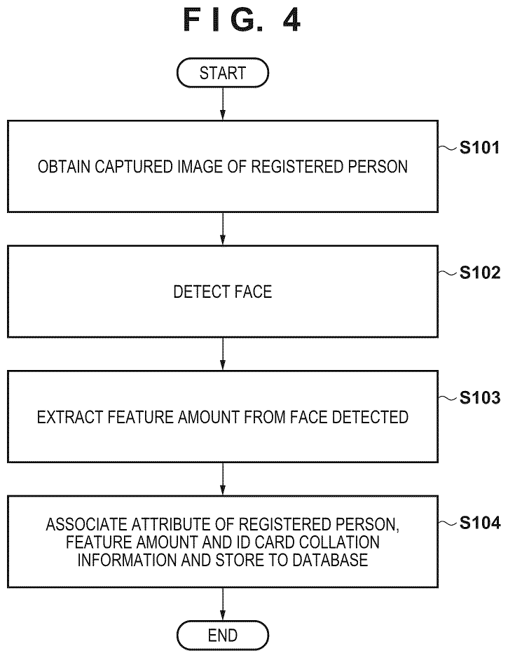

In the following, there will be described a method of processes (registration of information to be registered, face collation, and state measurement) to be performed by the information processing apparatus referring to FIGS. 4 to 9.

FIG. 4 is a flowchart of the registration process. At S102, the image obtaining unit 110 obtains, from the image capturing apparatus 200 or a user, a captured image of a person to be registered. At S102, the face detection unit 103 performs face detection on the image obtained at S101. At S103, the feature amount obtaining unit 104 extracts a face feature amount for face collation from a face region image detected at S102.

At S104, the registration unit 101 registers the feature amount extracted at S103, attributes of the person to be registered, and ID card collation information in the registration database 500 of the storage unit H104. The attributes of the person to be registered and the ID card collation information are input from the input unit H106 and set by an administrator or the like. As described above, attributes related to race, age, and gender are registered in the present embodiment.

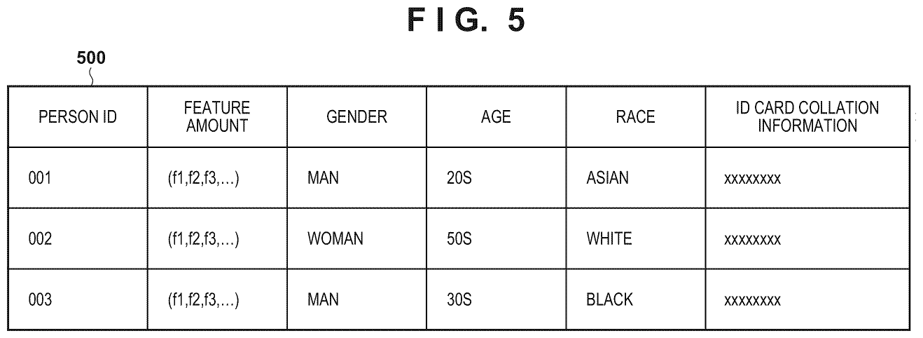

FIG. 5 illustrates an example of person information stored in a registration process. Specifically, an example of information (record) to be registered in the registration database 500 is illustrated. Here, age changes over time and therefore is assumed to be adjusted as appropriate.

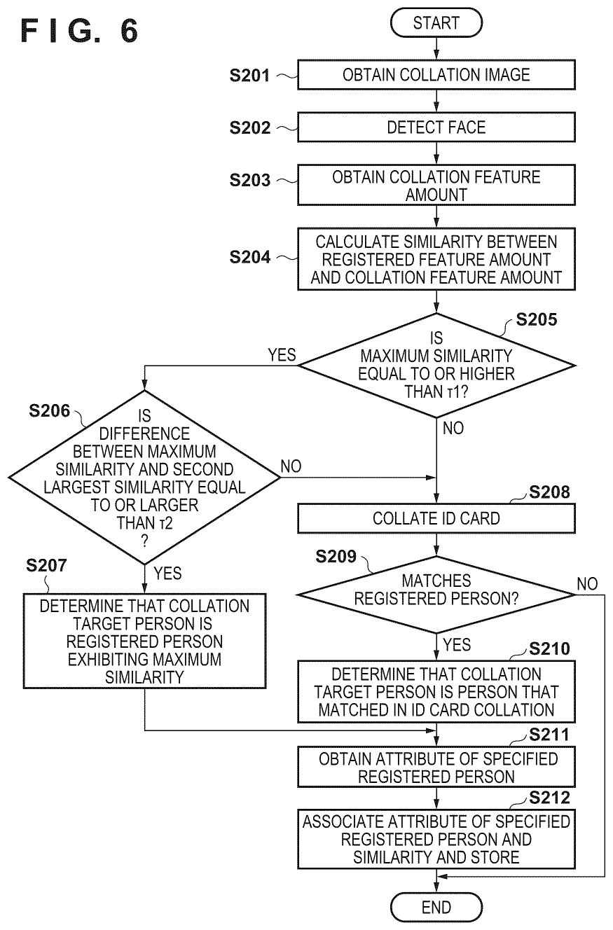

FIG. 6 is a flowchart of the collation process. Specifically, FIG. 6 illustrates the face collation process performed in the installation environment. Here, description is provided assuming that the collation system uses both face collation and ID card collation. Specifically, the collation system first performs face collation and, in a case where face collation fails, asks the user to present his/her ID card and performs personal collation using the ID card.

In addition, the process collects attribute similarity information to be used in a process of measuring the attribute-wise accuracy degradation state described below. The attribute-wise similarity information is information associating “attribute registered in the registration database 500”, “similarity collected in the installation environment”, and “flag indicating whether or not a similarity is the similarity with the person in question” with each other. In the case of “race”, for example, collection of attribute-wise similarity information is intended to separately collect similarities for Whites, Blacks, and Asians, respectively.

At S201, the image obtaining unit 102 obtains, from the image capturing apparatus 200, an image for collation (collation image) in which a collation target person appears. At S202, the face detection unit 103 detects a face region of the collation target person from the image obtained at S201. At S203, the feature amount obtaining unit 104 obtains a collation feature amount from the face region of the collation target person detected at S202.

At S204, the similarity calculation unit 105 calculates a similarity between the collation feature amount obtained at S203 and each registered feature amount from the registration database 500 stored in the storage unit H104. At S205, the face collation unit 106 determines whether or not the maximum similarity among the similarities calculated at S204 is equal to or higher than t1 (first threshold value). When the maximum similarity is equal to or higher than t1, the process proceeds to S206, otherwise the process proceeds to S208.

At S206, the face collation unit 106 determines whether or not the difference between the maximum similarity and the second largest similarity among the similarities calculated at S204 is equal to or larger than t2 (second threshold value), When the difference between the maximum similarity and the second largest similarity is equal to or higher than t2, the face collation unit 106 determines the reliability of the collation result to be high and the process proceeds to S207. When, on the other hand, the difference is smaller than t2, the face collation unit 106 determines that the reliability of the collation result is low and the process proceeds to S208.

At S207, the face collation unit 106 determines that the registered person exhibiting the maximum similarity is the collation target person, and performs an operation for successful collation such as key unlocking.

At S208, the notification unit 109 presents (to the collation target person, for example) that ID card collation is required, and accepts ID card collation information via the input apparatus 300. The notification unit 109 then checks whether or not there exists, among the registration information registered in the registration database 500, a piece of registration information that matches the accepted ID card collation information (ID card collation). At S209, the notification unit 109 determines, from the result of ID card collation performed at S208, whether or not a possible registered person exists in the storage unit H104. When there exists a possible registered person, the process proceeds to S210. Otherwise (i.e., both the face collation and the ID card collation failed), an operation for failed collation such as preventing key unlocking is performed and the process is terminated. At S210, the notification unit 109 determines that the registered person having matched at S209 is the collation target person, and performs an operation for successful collation such as key unlocking.

At S211, the attribute obtaining unit 107 obtains the attribute of the registered person (i.e., determination result) determined at S207 or S210 to be the person in question. Here, the attribute obtaining unit 107 reads the attributes related to race, age, and gender of the registered person from the registration database 500 of the storage unit H104.

At S212, the “attribute obtained at S211”, the “similarity calculated at S204”, and the “flag indicating whether or not the similarity is the similarity with the person in question” are stored in the registration unit 101 in association with each other as attribute-wise similarity information.

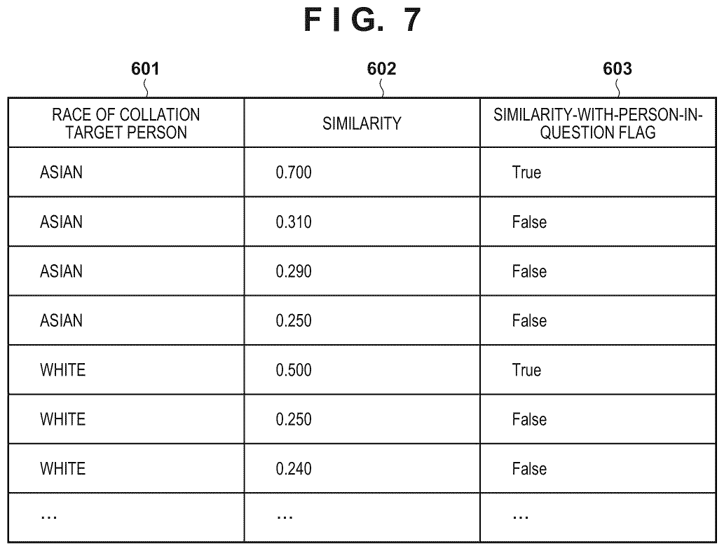

FIG. 7 illustrates an example of attribute-wise similarity information. The attribute-wise similarity information includes an attribute (race) 601 of the collation target person, a similarity 602, and a flag 603 indicating whether or not a similarity is the similarity with the person in question. Here, attribute-wise similarity information may also be generated for attributes related to age or gender.

Although an example of performing 1-to-N collation for the face collation (S205) has been explained in the foregoing description, the collation system may be configured to perform 1-to-1 collation. With 1-to-N collation, an attribute cannot be obtained unless ID card collation is performed in a case where face collation has failed. On the other hand, there is an advantage with 1-to-1 collation that the registered person to be collated has already been identified and therefore allows for obtaining an attribute without performing ID card collation.

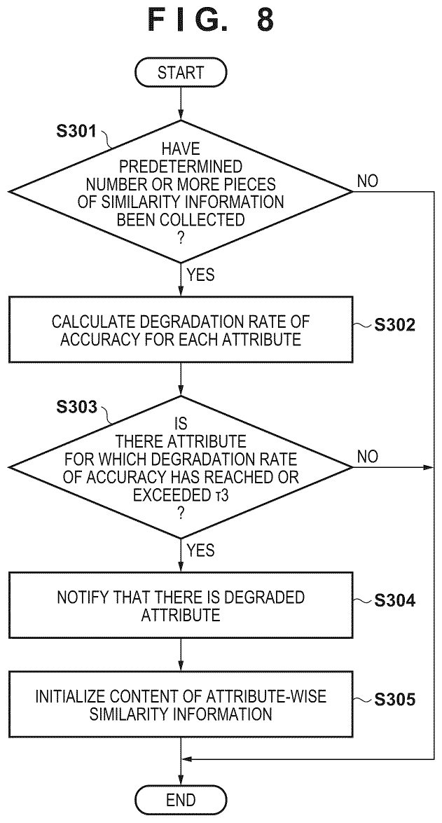

FIG. 8 is a flowchart of a state measurement process. Specifically, it is a flowchart of a process of measuring an attribute-wise accuracy degradation state using attribute-wise similarity information (i.e., history of determination results) collected at S212. The process is performed at regular intervals after the image capturing apparatus 200 is installed in an actual operation environment (i.e., under an image capturing environment of an actual operation environment). In addition, the process is also performed in a test environment before product shipment, in order to compare attribute accuracies before and after installation. Here, the process may be performed at an arbitrary timing after installation, in order to check the degradation state.

At S301, the state measurement unit 108 determines whether a predetermined number or more of pieces of attribute-wise similarity information have been collected at S212. When a predetermined number of pieces have been collected, the process proceeds to the S302. When a predetermined number of pieces have not yet been collected, the process is terminated without determining the degradation state.

At S302, the state measurement unit 108 calculates, from the attribute-wise similarity information collected at S212, a degradation rate of attribute-wise accuracy for each attribute category. In the present embodiment, the attribute-wise determination accuracy is derived for each race, gender, and age, which are attribute categories. Here, a degradation rate R1 (i) of a stranger acceptance rate calculated by Equation (1) is calculated.

$$R 1 ( i ) = {FAR}_{i} / {FAR}_{all} \qquad ( 1 )$$

Here, i indicates the i-th attribute in the attribute category. When, for example, the attribute category is “race” and attributes in the attribute category are arranged in the order of [White, Black, Asian], the attribute for i=2 is “Black”.

FARᵢ is a stranger acceptance rate for a certain attribute i for the threshold value τ1. FARₐₗₗ is the overall stranger acceptance rate for the threshold value τ1. FARᵢ is calculated by Equation (2).

$${FAR}_{i} = {N}_{i , other , score >= τ 1} / {N}_{i , other} \qquad ( 2 )$$

N_{i, other} indicates a number of similarities with strangers for a certain attribute i. A similarity with a stranger indicates a similarity for which a flag indicating whether or not the similarity is the similarity with the person in question is False, as indicated by the reference numeral 603 in FIG. 7. N_{i, other, score>=τ1} indicates a number of similarities that are equal to or larger than the threshold value τ1, among the numbers of similarities with strangers for a certain attribute i. FARₐₗₗ is calculated by Equation (3).

$${FAR}_{all} = {N}_{other , score >= τ 1} / {N}_{other} \qquad ( 3 )$$

Nₒₜₕₑᵣ indicates a number of similarities with strangers. N_{other, score>=τ1} indicates a number of similarities that are equal to or larger than the threshold value τ1, among the numbers of similarities with strangers. Alternatively, a degradation rate R2(i) of an attribute-wise false rejection rate calculated by Equation (4) may be used.

$$R 2 ( i ) = {FRR}_{i} / {FRR}_{all} \qquad ( 4 )$$

Here, i indicates the i-th attribute in the attribute category. FRRᵢ is calculated by Equation (5).

$${FRR}_{i} = {N}_{i , same , score < τ 1} / {N}_{i , same} \qquad ( 5 )$$

N_{i, same} indicates a number of similarities with the person in question for a certain attribute i. A similarity with the person in question refers to a similarity for which the similarity-with-person-in-question flag 603 in FIG. 7 is True. N_{i, same, score<τ1} indicates a number of similarities that are lower than the threshold value τ1, among the similarities with the target person for a certain attribute i. FRRₐₗₗ is calculated by Equation (6).

$${FRR}_{all} = {N}_{same , score < τ 1} / {N}_{same} \qquad ( 6 )$$

Nₛₐₘₑ indicates a number of similarities with the person in question. N_{same, score<τ1} indicates a number of similarities that are lower than the threshold value τ1, among the similarities with the target person.

At S303, the state measurement unit 108 determines that there is a degradation of the accuracy of the attribute whose degradation rate of attribute-wise accuracy calculated at S302 has reached or exceeded t3 (third threshold value). Alternatively, degradation may be determined when the accuracy degradation rate has exceeded that of the previous time (before product shipment or at the previous measurement) by a certain threshold width or more.

Comparison with the accuracy before product shipment reveals the degree of deviation of the current installation environment from the initially assumed installation environment. In addition, comparison with the previous-time measurement reveals the trend of degradation of the attribute-wise accuracy over time in the installation environment. When degradation has been determined, the process proceeds to S304. Otherwise the process terminates.

Here, the degradation rate of stranger acceptance rate and the degradation rate of false rejection rate are index values indicating whether or not a certain attribute has degraded relative to all the other attributes. When it is desired to detect degradation of the absolute value of accuracy, the collation system may be configured to determine whether or not the stranger acceptance rate (or false rejection rate) for each attribute has exceeded a predetermined value. Alternatively, both the degradation rate and the aforementioned absolute index value may be used together.

At S304, the notification unit 109 notifies the installation personnel or the like that a degraded attribute has been detected at S303, together with the degradation rate of attribute-wise accuracy. At S305, the state measurement unit 108 initializes the attribute-wise accuracy degradation information, in order to calculate the attribute-wise accuracy degradation rate for the next collection period of attribute-wise similarity information.

According to the first embodiment as has been described above, it is possible to detect the accuracy degradation state using the temporal change in the similarity calculated at the time of face collation. In particular, it is possible to detect the attribute-wise accuracy degradation state for each attribute category such as race, gender, and age. Therefore, it becomes possible to grasp a state such as, for example, “the face collation accuracy of Blacks or women has degraded in the installation environment by a larger degree than expected in comparison with other attributes”.

In addition, it is also possible to detect which of the attribute categories has degraded by obtaining maximum values for respective attribute categories (instead of attributes) in a similar comparison process. Accordingly, it becomes possible to grasp a state such as “the age attribute has degraded instead of the race attribute”. Furthermore, accuracy degradation may be detected for each attribute set provided as a product of a plurality of attribute categories such as “Asian women in their 40's”.

### Modification

In the first embodiment, there has been described a case of a unique attribute belonging to an individual such as race, gender, and age as attribute categories. However, it is also possible to use other attributes that may change depending on the environment or usage condition such as “presence or absence of a mask”. “degree of noise”, or the like.

Since the attributes for detecting accuracy degradation in the present modification are those obtained from collation images, feature amounts other than attributes and ID card collation information are stored in the registration database 500 at S104 of the registration process of the present modification. Other components are similar to those of the first embodiment and therefore description thereof will be omitted. In the collation process, the attributes “presence or absence of a mask” and “degree of noise” are obtained from the collation image as described above. Other processes are similar to those of the first embodiment and therefore description thereof will be omitted.

Presence or absence of a mask is determined by detecting a mask from a collation image. A known method is used for mask detection. The degree of noise is obtained by calculating a noise amount from the collation image and classifying the noise amount according to a predetermined value range. A known method is used for calculating the amount of noise.

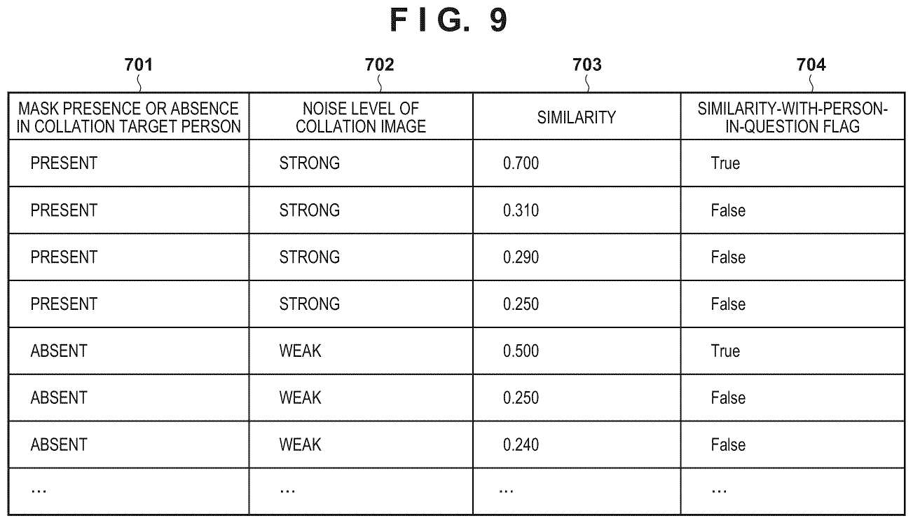

FIG. 9 illustrates an example of attribute-wise similarity information according to the modification. The attribute-wise similarity information includes a mask presence or absence 601 of a collation target person, a noise level 602 of a collation image, a similarity 603, and a similarity-with-person-in-question flag 604.

As described above, even for an attribute such as “presence or absence of a mask” or “degree of noise” that may change depending on the usage environment, usage condition, or the like, it is possible to detect its attribute-wise accuracy degradation state.

### Second Embodiment

In a second embodiment, there will be described a method that also performs attribute estimation of a collation target person in parallel with the face collation process, and detects an attribute-wise accuracy degradation state from differences among attribute-wise population distributions. In other words, although the attribute of the collation target person is obtained from preliminarily registered information in the first embodiment, the second embodiment is different in that the attribute of the collation target person is obtained via attribute estimation.

Here, the configuration of the collation system (FIG. 1) and the hardware configuration (FIG. 2) of the information processing apparatus 100 are similar to those in the first embodiment and therefore description thereof will be omitted.

### Apparatus Configuration

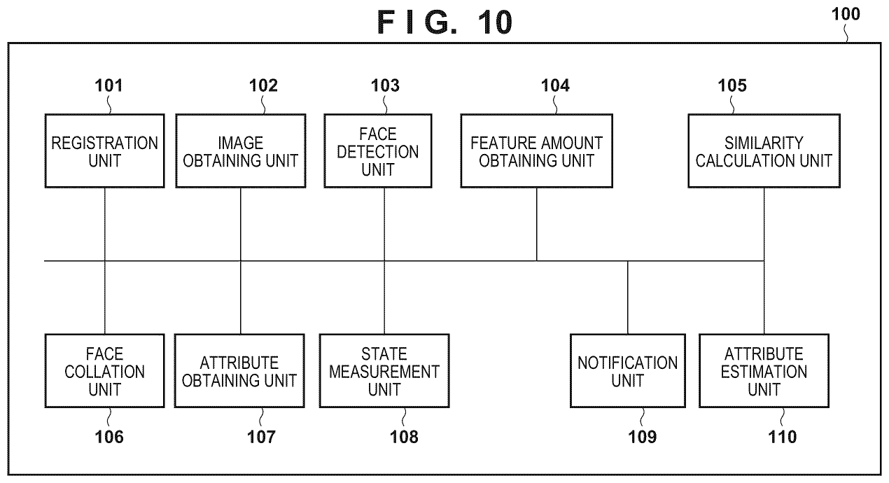

FIG. 10 illustrates an example of a functional configuration of an information processing apparatus related to the second embodiment. Here, components bearing the same reference numerals as those in the first embodiment are similar to those in the first embodiment, and therefore description thereof will be omitted.

The attribute estimation unit 110 estimates an attribute of a person from a face region image of the person. A known method is used for the attribute estimation method.

### Apparatus Operation

The registration process performed by the registration unit 101 is the same as that of the first embodiment, and therefore description thereof will be omitted.

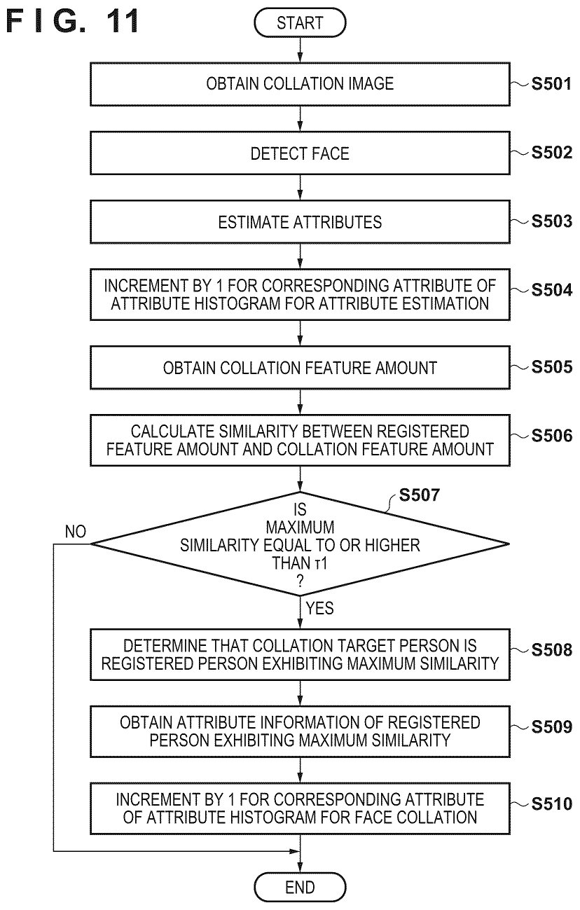

FIG. 11 is a flowchart of a collation process according to the second embodiment. In the flowchart, an attribute histogram for face collation and an attribute histogram for attribute estimation used for detecting an attribute-wise accuracy degradation state are generated, in parallel with the face collation process. The attribute histogram does not exist only for a single attribute category (race, gender, or the like) and there may exist respective attribute histograms for a plurality of attribute categories.

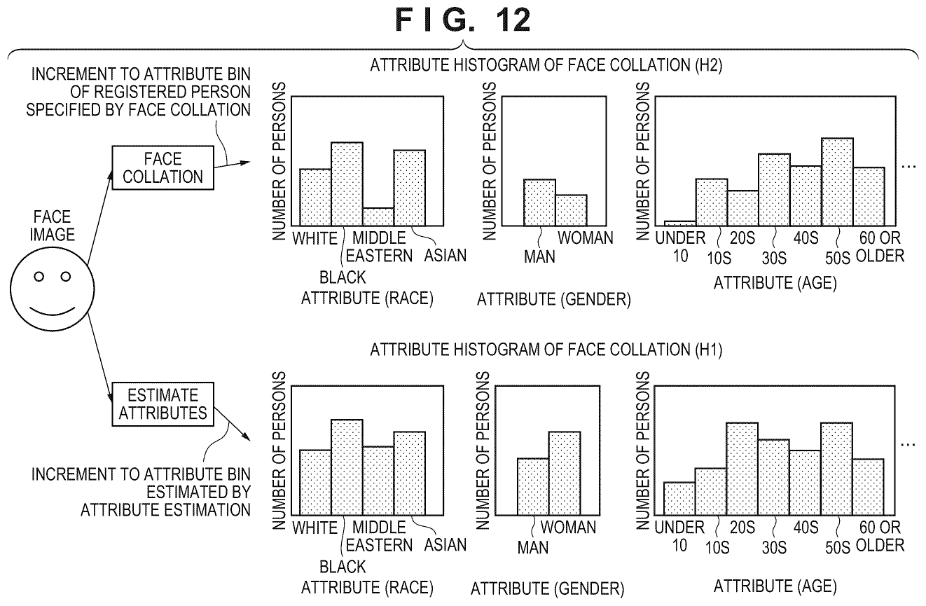

At S501, the image obtaining unit 102 obtains, from the image capturing apparatus 200, an image in which the collation target person appears. At S502, the face detection unit 103 detects a face region of the collation target person from the captured image obtained at S501. At S503, the attribute estimation unit 110 estimates, from the face region image of the collation target person obtained at S502, a plurality of attributes whose degradation states are desired to be detected. At S504, the attribute estimation unit 110 increments by 1 the bin corresponding to the attribute estimated at S503 among the bins of the attribute histogram for attribute estimation. An attribute histogram for attribute estimation is a histogram for each attribute category (race, gender, age, etc.) as illustrated in FIG. 12.

FIG. 12 is an explanatory diagram of collecting attribute histograms. In the second embodiment, two types of histograms, namely an attribute histogram H1 for attribute estimation and an attribute histogram H2 for face collation are generated for each attribute category (race, gender, and age).

At S505, the feature amount obtaining unit 104 obtains the collation feature amount from the face region of the collation target person detected at S502. At S506, the similarity calculation unit 105 calculates the similarity between the collation feature amount obtained at S505 and each registered feature amount in the registration information.

At S507, the face collation unit 106 determines whether or not the maximum similarity among the similarities calculated at S506 is equal to or higher than τ1. When the maximum similarity is equal to or higher than τ1, the process proceeds to S508, otherwise the process is terminated.

At S508, the face collation unit 106 determines that the collation target person is the registered person exhibiting the maximum similarity, and performs an operation for successful face collation such as key unlocking. At S509, the attribute obtaining unit 107 obtains, from the registration unit 101, the attribute of the registered person determined at S508. At S510, the attribute obtaining unit 110 increments by 1 a bin corresponding to the attribute obtained at S509 among the bins of the attribute histogram for face collation.

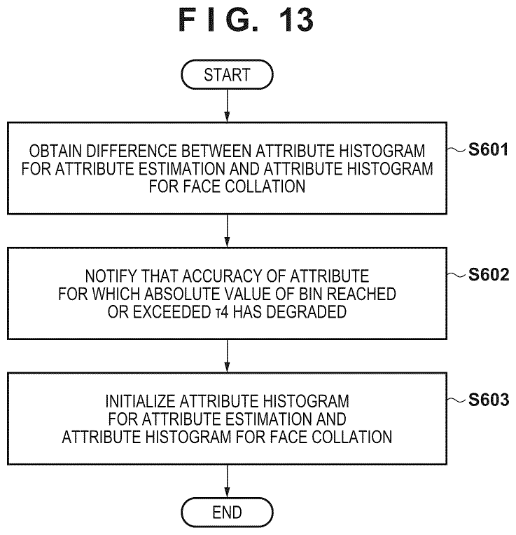

FIG. 13 is a flowchart of the state measurement process according to the second embodiment. Specifically, the attribute-wise accuracy degradation state is measured from the attribute histogram for face collation and the attribute histogram for attribute estimation collected in FIG. 11. The process is performed when, for example, the total number of all the bins of the attribute histogram for attribute estimation collected at S504 and the attribute histogram for face collation collected at S510 becomes equal to or larger than a predetermined number.

At S601, the state measurement unit 108 obtains a difference between the attribute histogram for attribute estimation and the attribute histogram for face collation as indicated by Equation (7).

Hdiff(i)=Hatt(i)−Hface(i) (7)

Hatt represents the attribute histogram for attribute estimation, Hface represents the attribute histogram for face collation, and Hdiff represents the difference.

Here, i indicates the i-th attribute in the attribute category. When, for example, the attribute category is “race” and attributes in the attribute category are arranged in the order of [White, Black, Asian], the attribute for i=2 is “Black”.

At S602, the state measurement unit 108 obtains an attribute for which the absolute value of the bin reached or exceeded 14 (fourth threshold value) among the differences obtained at S601, and notifies the installation personnel or the like that the accuracy of the attribute has degraded.

When failed to find a corresponding registered person in the face collation (miscollation), the corresponding bin of the attribute histogram for face collation is not incremented. On the other hand, the corresponding bin of the attribute histogram for attribute estimation is incremented. Accordingly, frequent occurrence of miscollation in a certain attribute may result in deviation of the frequencies of both histograms from each other. Therefore, it is possible to detect the attribute-wise accuracy degradation state by detecting an attribute exhibiting an increased accuracy difference.

In addition, when a registered person whose attribute is different from that of the collation target person has been collated as the person in question (erroneous collation), the corresponding bin of the attribute histogram for face collation is not incremented, but the bin of the attribute of the registered person who has been erroneously collated is incremented. On the other hand, the corresponding bin of the attribute histogram for attribute estimation is incremented. Accordingly, frequent occurrence of erroneous collation for a certain attribute may result in deviation of frequencies between the bin of the attribute of the collation target person and the bin of the attribute of the registered person who has been erroneously collated. Therefore, it is possible to detect the attribute-wise accuracy degradation state by extracting an attribute exhibiting an absolute value of accuracy difference that is equal to or larger than the threshold value.

In addition, there is also conceivable a case where it is desired to detect accuracy imbalance between attributes. For example, there is a case where the accuracy significantly degrades only for a certain attribute under a certain illumination condition. Accordingly, there is conceivable a case where it is desired to detect only an attribute with a significantly degraded accuracy. In such a case, a normalized difference (Hnorm) is created by dividing each bin by the total sum of all bins to normalize the difference Hdiff obtained at S601 as illustrated in Equation (8). When there exists an attribute with the absolute value of the bin being equal to or larger than a certain value, it may be considered that accuracy imbalance between attributes has been detected.

Hnorm(i)=Hdiff(i)/Σᵢ(Hdiff(i)) (8)

Here, i indicates the i-th attribute in the attribute category.

At S603, the state measurement unit 108 initializes the attribute histogram for attribute estimation and the attribute histogram for face collation.

According to the second embodiment as has been described above, it is possible to detect the attribute-wise accuracy degradation state from the difference between the attribute-wise number of persons with whom face collation has succeeded and the attribute-wise number of persons estimated by attribute estimation.

Although the above description has mainly explained an example of detecting an attribute with degraded accuracy among an attribute category such as race or gender, an attribute with degraded accuracy may be detected from a plurality of attribute categories. For example, the collation system may be configured to detect that the accuracy of Blacks and women has degraded. In addition, accuracy degradation may be detected for each attribute set provided as a product of a plurality of attribute categories such as “Asian women in their 40's”.

### Third Embodiment

A third embodiment, describes a form of detecting attribute-wise accuracy degradation by detecting that distributions of collation images are deviated for two different periods.

One of the causes of accuracy degradation of the face collation process may be that the image capturing environment and the distribution of appearance of persons in collation images have deviated from the initially assumed distribution. The third embodiment therefore compares the ratios of the attribute histogram for face collation result and the attribute histogram for attribute estimation, respectively, in two different periods, with respect to a plurality of attribute categories for which degradation states are desired to be grasped. As a result, it is detected whether or not distributions of collation images deviate between the two periods.

Here, the configuration of the collation system (FIG. 1) and the hardware configuration (FIG. 2) of the information processing apparatus 100 are similar to those in the first embodiment and therefore description thereof will be omitted. In addition, the functional configuration (FIG. 10) of the information processing apparatus 100 is the same as that of the second embodiment, and therefore description thereof will be omitted.

### Apparatus Operation

The registration process performed by the registration unit 101 is the same as that of the first embodiment, and therefore description thereof will be omitted.

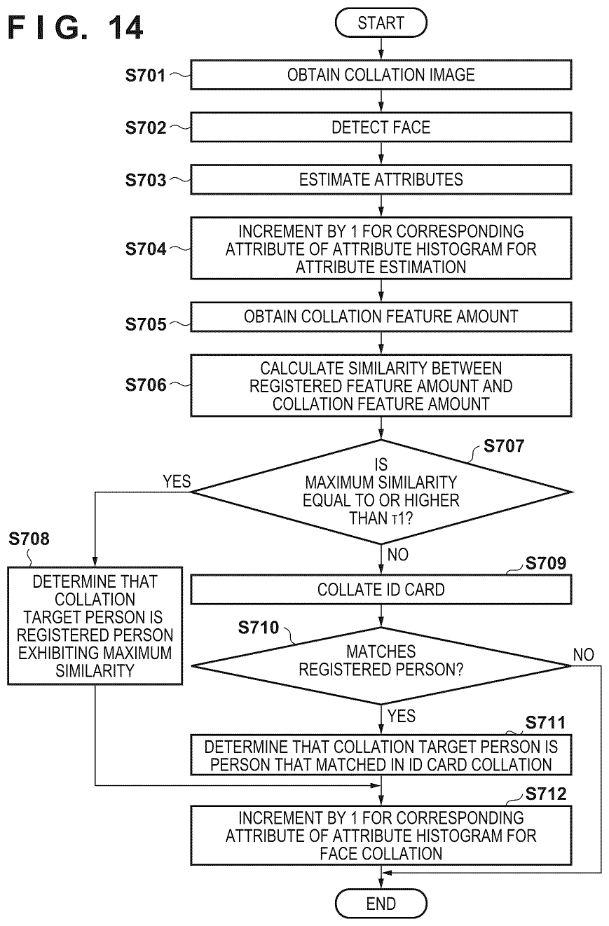

FIG. 14 is a flowchart of the collation process according to the third embodiment. The attribute histograms for face collation and the attribute histogram for attribute estimation are collected by the process illustrated in the flowchart.

At S701, the image obtaining unit 102 obtains, from the image capturing apparatus 200, an image in which the collation target person appears. At S702, the face detection unit 103 detects a face region of the collation target person from the image obtained at S701. At S703, the attribute estimation unit 110 performs attribute estimation using the face region of the collation target person detected at S702 as an input. Attributes of a plurality of attribute categories may be output as a result of attribute estimation. In the aforementioned case, an attribute such as, for example, “black woman in her 30's” may be output.

At S704, the attribute estimation unit 110 increments by 1 the bin of the attribute estimated at S703, among the bins of the attribute histogram H1 for attribute estimation existing for each attribute category. When a plurality of attributes have been estimated at S703, the bin of each estimated attribute is incremented by one.

At S705, the feature amount obtaining unit 104 obtains the collation feature amount from the face region image of the collation target person obtained at S702. At S706, the similarity calculation unit 105 calculates the similarity between the collation feature amount obtained at S705 and each registered feature amount in the registration information. At S707, the face collation unit 106 determines whether or not the maximum similarity among the similarities calculated at S706 is equal to or higher than τ1. When the maximum similarity is equal to or higher than τ1, the process proceeds to S708, otherwise the process proceeds to S709. At S708, the face collation unit 106 determines that the registered person exhibiting the maximum similarity is the collation target person, and performs an operation for successful collation such as key unlocking.

At S709, the notification unit 109 presents (to the collation target person, for example) that ID card collation is required and accepts ID card collation information via the input apparatus 300. The notification unit 109 then checks whether or not there exists, among the registration information registered in the registration database 500, a piece of registration information that matches the accepted ID card collation information (ID card collation).

At S710, the notification unit 109 determines, from the result of ID card collation performed at S709, whether or not a possible registered person exists in the storage unit H104. When there exists a possible registered person, the process proceeds to S711. Otherwise (i.e., both the face collation and the ID card collation failed), an operation for failed collation such as preventing key unlocking is performed and the process is terminated. At S711, the notification unit 109 determines that the registered person matched at S710 is the collation target person, and performs an operation for successful collation such as key unlocking.

At S712, the attribute obtaining unit 107 increments by 1 a bin corresponding to the attribute of the registered person determined to be the person in question at S708 or S711, among the bins of the attribute histogram H2 for face collation. When a plurality of attributes have been estimated at S703, the bin of each estimated attribute is incremented by one.

Processes of generating the aforementioned attribute histogram H1 for attribute estimation and the attribute histogram H2 for face collation are respectively performed in two different periods (referred to period 1 and period 2).

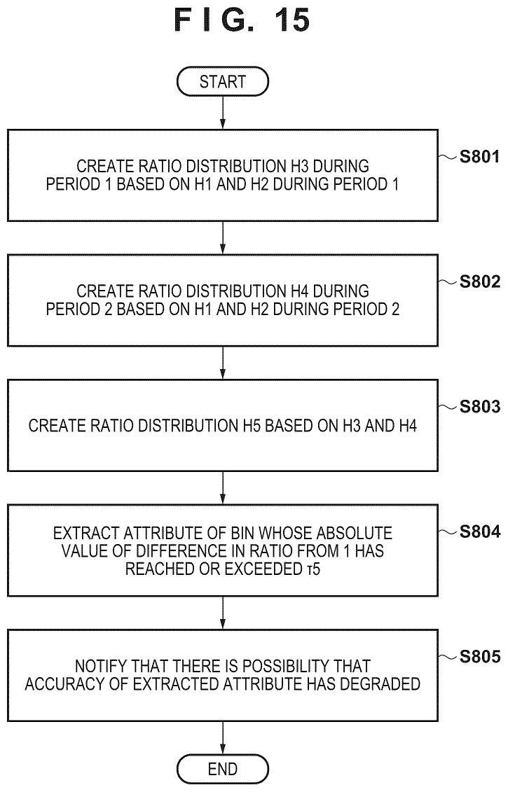

FIG. 15 is a flowchart of the state measurement process according to the third embodiment. Here, the attribute-wise accuracy degradation state is measured from the attribute histogram H1 for attribute estimation and the attribute histogram H2 for face collation, which have been collected in two different periods.

At S801, the state measurement unit 108 divides each bin of the attribute histogram H1 of the attribute estimation collected during the period 1 by each bin of the attribute histogram H2 of the face collation collected during the period 1 to create a ratio distribution H3 during the period 1. At S802, the period state measurement unit 108 divides each bin of the attribute histogram H1 of the attribute estimation collected during the period 2 by each bin of the attribute histogram H2 of the face collation collected during the period 2 to create a ratio distribution H4 over the period 2.

At S803, the state measurement unit 108 divides each bin of the ratio distribution H3 for the period 1 by each bin of the ratio distribution H4 for the period 2 to create a ratio distribution H5. At S804, the attribute of the bin whose absolute value of the difference in ratio from 1 has reached or exceeded 15 (fifth threshold value) is extracted, among the bins of the ratio distribution H5.

As the distribution (appearance, capturing environment, or the like) of the images of the collation target person captured during the period 1 and the period 2 becomes different to an extent that may affect the face collation accuracy, it is conceivable that the attribute distribution of the attribute estimation result and the attribute distribution of the registered person identified by face collation exhibit different trends. An attribute exhibiting such a change may have the value of the corresponding bin of the ratio distribution H5 created at S803 during the period 1 and the period 2 falling out of the range of 1±τ5. Therefore, an attribute with a possible accuracy degradation is extracted by extracting an attribute of a bin whose absolute value of the difference in ratio from 1 has reached or exceeded the threshold value (15), among the bins of the ratio distribution H5.

At S805, when there exists an attribute extracted at S804, the notification unit 109 notifies the installation personnel or the like that the accuracy of the attribute has degraded.

According to the third embodiment as has been described above, it is possible to detect the attribute-wise accuracy degradation state based on the difference in the change trend between the attribute histogram provided by face collation and the attribute histogram provided by attribute estimation.

Although the above description has mainly explained an example of detecting an attribute with degraded accuracy among an attribute category such as race or gender, an attribute with degraded accuracy may be detected from a plurality of attribute categories. For example, the collation system may be configured to detect that the accuracy of Blacks and women has degraded. In addition, accuracy degradation may be detected for each attribute set provided as a product of a plurality of attribute categories such as “Asian women in their 40's”.

### Fourth Embodiment

A fourth embodiment describes a form of checking whether or not the results of two different attribute aggregating methods match and, it is determined that the collation system is normally operating when the results match, otherwise it is determined that an abnormality has occurred. “Collection of attributes associated with a registered person determined to be the person in question (by face collation or ID card collation)” and “collection of attributes estimated by attribute estimation” are used as two different attribute aggregation methods. With the aforementioned methods, it is possible to detect an event in which it is highly possible that accuracy degradation has occurred, such as when distribution of an input image (image capturing environment or manner of appearance of a person) has deviated from the initially assumed distribution.

Before factory shipment, the present embodiment first performs a learning process on an attribute estimator so that the attribute estimation results in a same attribute as that of the registered person identified by the face collation process, when a same image has been input to the face collation process and the attribute estimation process. The aforementioned setting results in that the attribute histogram provided by the face collation process and the attribute histogram provided by attribute estimation become substantially the same, and therefore it is possible to detect, from the degree of deviation of both histograms after installation, whether or not the distribution of the input image has deviated from the initially assumed distribution.

### Apparatus Configuration

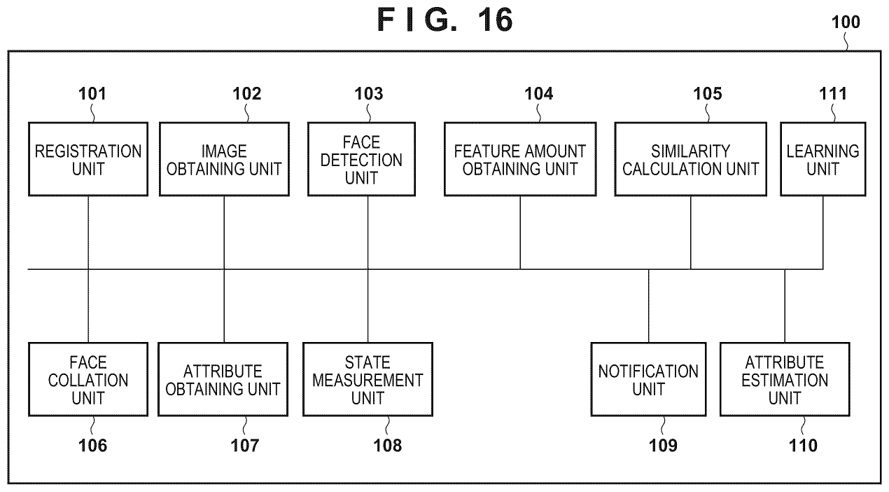

FIG. 16 illustrates a functional configuration of an information processing apparatus according to the fourth embodiment. Components bearing the same reference numerals as those in the first and the second embodiments are similar to those in the first and the second embodiments, and therefore description thereof will be omitted.

A learning unit 111 performs a learning process on the attribute estimator to be used by the attribute estimation unit 110. The method of the learning process will be described below.

### Apparatus Operation

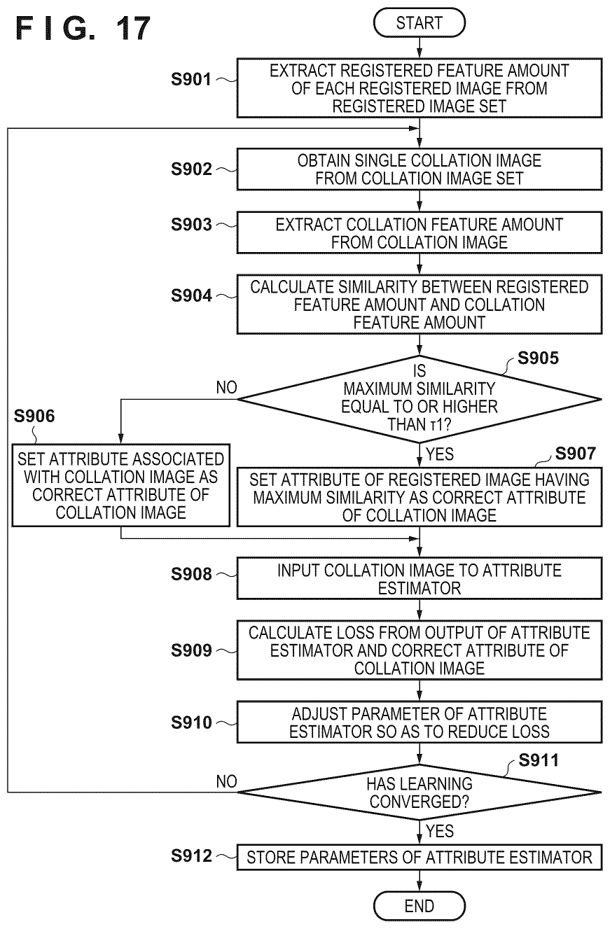

FIG. 17 is a flowchart of the learning process. As has been described above, the learning unit 111 performs a learning process on the attribute estimator to be used by the attribute estimation unit 110.

At S901, the image obtaining unit 102 obtains a set of registered images prepared for learning by the attribute estimator. The feature amount obtaining unit 104 then extracts registered feature amounts of respective registered images. It is assumed that each image in the registered image set has an attribute associated therewith. At S902, the image obtaining unit 102 obtains a single collation image from the collation image set prepared for learning by the attribute estimator. It is assumed that each image of the collation image set has an attribute associated therewith. At S903, the feature amount obtaining unit 104 extracts a collation feature amount from the collation image obtained at S902.

At S904, the similarity calculation unit 105 calculates the similarity between the registered feature amount obtained at S901 and the collation feature amount obtained at S903. At S905, the face collation unit 106 determines whether or not the maximum similarity among the similarities calculated at S904 is equal to or higher than τ1. When the maximum similarity is equal to or higher than τ1, the process proceeds to S907, otherwise the process proceeds to S906.

At S906, the attribute obtaining unit 107 sets the attribute associated with the collation image as the correct attribute of the collation image. At S907, the attribute obtaining unit 107 sets the attribute associated with the registered image having the maximum similarity among the similarities calculated at S904 as the correct attribute of the collation image.

At S908, the attribute estimation unit 110 inputs the collation image to the attribute estimator and obtains the result of estimation by the attribute estimator. At S909, the learning unit 111 calculates a collation loss from the estimation result obtained at S908 and the correct attribute obtained at S906 or S907. A cross entropy loss used for multi-class classification, for example, is used for loss calculation. At S910, the learning unit 111 adjusts the parameter of the attribute estimator of the attribute estimation unit 110 so as to reduce the loss calculated at S909.

At S911, the learning unit 111 repeats the learning process from S902 to S910 until the learning converges or execution has been completed for a predetermined number of times. Upon completion of the learning process, the process proceeds to S912. At S912, the learning unit 111 stores parameters of the attribute estimator of the attribute estimation unit 110 in the storage unit H104.

The registration process performed by the registration unit 101 is the same as that of the first embodiment, and therefore description thereof will be omitted. In addition, the collation process performed by the face collation unit 106 is the same as that in the third embodiment, and therefore description thereof will be omitted.

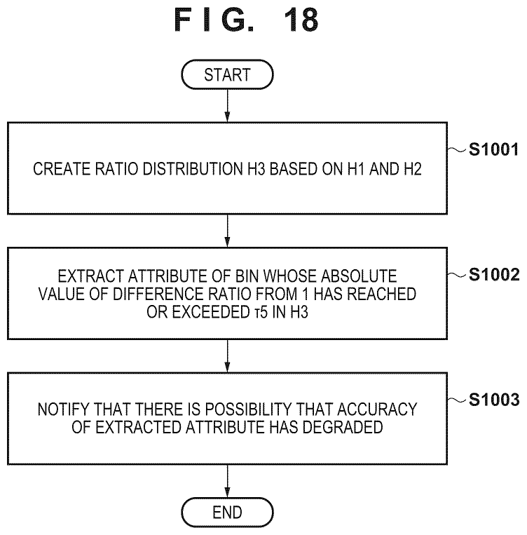

FIG. 18 is a flowchart of the state measurement process according to the fourth embodiment. Although the process of collecting the histogram illustrated in FIG. 14 is performed during two different periods in the third embodiment, the process is performed in the fourth embodiment for only one period after installation in an actual environment to check whether or not a predetermined performance has been achieved.

At S1001, the state measurement unit 108 divides each bin of the attribute histogram H1 for attribute estimation by each bin of the attribute histogram H2 for face collation to create a ratio distribution H3 as illustrated in Equation (9).

$$H 3 ( i ) = H 1 ( i ) / H 2 ( i ) \qquad ( 9 )$$

Here, i indicates the i-th attribute in the attribute category.

At S1002, the state measurement unit 108 extracts an attribute of a bin whose absolute value of the difference f ratio from 1 has reached or exceeded t5 in the ratio distribution H3. At S1003, when there exists an attribute extracted at S1002, the notification unit 109 notifies the installation personnel or the like that the accuracy of the attribute has degraded.

According to the fourth embodiment as has been described above, it is determined, from comparison between the results of two different attribute aggregation methods, namely face collation and attribute estimation, whether or not the distribution of the input image has deviated from what has been assumed. Based on the aforementioned determination, an event exhibiting a very likely occurrence of attribute-wise accuracy degradation is detected.

Although the above description has mainly explained an example of detecting an attribute with degraded accuracy among an attribute category such as race or gender, an attribute with degraded accuracy may be detected from a plurality of attribute categories. For example, the collation system may be configured to detect that the accuracy of Blacks and women has degraded. In addition, accuracy degradation may be detected for each attribute set provided as a product of a plurality of attribute categories such as “Asian women in their 40's”.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-088069, filed May 29, 2023 which is hereby incorporated by reference herein in its entirety.

What is claimed is:

1. An image processing apparatus comprising one or more memories storing instructions and one or more processors that execute the instructions to:
obtain image features of a collation target person;
obtain a plurality of registered image features corresponding to a plurality of persons respectively associated with correct answer values of a plurality of attributes;
calculate a similarity between the image features and each of the plurality of registered image features;
determine to which of the plurality of persons the collation target person corresponds, based on the calculated similarity;
derive an attribute-wise determination accuracy included in the plurality of attributes, based on a history in which the calculated similarity and the result of determination are associated with each other; and
compare, for each attribute, a first determination accuracy derived based on first image features based on an image captured under a first image capturing environment and a second determination accuracy derived based on second image features based on an image captured under a second image capturing environment, and detect an attribute exhibiting an accuracy difference equal to or larger than a predetermined threshold value.

2. The image processing apparatus according to claim 1, wherein
the first image capturing environment is a test environment, and the second image capturing environment is an actual operation environment.

3. The image processing apparatus according to claim 1, wherein
the first image capturing environment is an actual operation environment during a first period, and the second image capturing environment is an actual operation environment during a second period which is different from the first period.

4. The image processing apparatus according to claim 1, wherein the one or more processors execute the instructions to:
notify, if an attribute exhibiting an accuracy difference equal to or larger than the predetermined threshold value id detected, information related to the attribute or an attribute category including the attribute.

5. The image processing apparatus according to claim 1, wherein
it is determined that the collation target person is a person exhibiting registered image features corresponding to a maximum similarity if a maximum similarity calculated for the image features is equal to or higher than a first threshold value and a difference between the maximum similarity and the second largest similarity calculated for the image features is equal to or higher than a second threshold value.

6. The image processing apparatus according to claim 5, wherein
each of the plurality of persons has identification information preliminarily set thereto,
wherein the one or more processors execute the instructions to accept identification information from the collation target person, and
if the maximum similarity is lower than the first threshold value or the difference is smaller than the second threshold value, it is determined which of the plurality of persons the collation target person corresponds to, based on the identification information accepted from the collation target person.

7. The image processing apparatus according to claim 1, wherein
the predetermined threshold value is set as a ratio with respect to the first determination accuracy, or a difference with respect to the first determination accuracy.

8. The image processing apparatus according to claim 1, wherein
the plurality of registered image features are obtained from a preliminarily prepared database.

9. An image processing apparatus comprising one or more memories storing instructions and one or more processors that execute the instructions to:
obtain image features of a collation target person;
estimate a plurality of attributes of the collation target person based on an image of the collation target person;
obtain a plurality of registered image features corresponding to a plurality of persons respectively associated with correct answer values of a plurality of attributes;
calculate a similarity between the image features and each of the plurality of registered image features;
determine to which of the plurality of persons the collation target person corresponds, based on the calculated similarity; and
compare a first attribute histogram generated based on the history of the estimated plurality of attributes and a second attribute histogram generated based on the history of the plurality of attributes corresponding to the determined person for each attribute, and detect an attribute exhibiting an accuracy difference equal to or larger than a predetermined threshold value.

10. The image processing apparatus according to claim 9, wherein
it is determined that the collation target person is a person exhibiting registered image features corresponding to the maximum similarity, if the maximum similarity calculated with respect to the image features is equal to or higher than a first threshold value.

11. The image processing apparatus according to claim 10, wherein
each of the plurality of persons has identification information preliminarily set thereto,
wherein the one or more processors execute the instructions to accept identification information from the collation target person, and
if the maximum similarity is lower than the first threshold value, it is determined which of the plurality of persons the collation target person corresponds to, based on the identification information accepted from the collation target person.

12. An image processing apparatus comprising one or more memories storing instructions and one or more processors that execute the instructions to:
obtain image features of a collation target person;
estimate a plurality of attributes of the collation target person based on an image of the collation target person;
obtain a plurality of registered image features corresponding to a plurality of persons respectively associated with correct answer values of a plurality of attributes;
calculate a similarity between the image features and each of the plurality of registered image features; and
determine to which of the plurality of persons the collation target person corresponds, based on the calculated similarity;
generate a first ratio distribution obtained by dividing a value of each bin of a first attribute histogram generated based on a history of a plurality of attributes estimated based on an image captured under a first image capturing environment by a value of each bin of a second attribute histogram generated based on a history of a plurality of attributes corresponding to a person determined based on image features of the image captured under the first image capturing environment;
generate a second ratio distribution obtained by dividing a value of each bin of a third attribute histogram generated based on the history of the plurality of attributes estimated based on the image captured under the second image capturing environment by a value of each bin of a fourth attribute histogram generated based on the history of the plurality of attributes corresponding to the person determined based on the image features of the image captured under the second image capturing environment; and
compare the first ratio distribution and the second ratio distribution for each attribute and detect an attribute exhibiting an accuracy difference equal to or larger than a predetermined threshold.

13. The image processing apparatus according to claim 12, wherein the one or more processors execute the instructions to:
perform a learning process on an estimator to be used for estimation, wherein
the learning process on the estimator is performed so as to reduce a difference between the first attribute histogram and the second attribute histogram, and
an attribute of a bin whose difference in ratio from 1 is equal to or higher than a predetermined threshold value is detected, among the ratios of respective bins in the first ratio distribution.

14. A control method of an image processing apparatus, comprising:
obtaining image features of a collation target person;
obtaining a plurality of registered image features corresponding to a plurality of persons respectively associated with correct answer values of a plurality of attributes;
calculating a similarity between the image features and each of the plurality of registered image features;
determining to which of the plurality of persons the collation target person corresponds, based on the similarity calculated in the calculating;
deriving attribute-wise determination accuracy included in the plurality of attributes based on a history in which the similarity calculated in the calculating and the result of determination in the determining are associated with each other; and
comparing, for each attribute, a first determination accuracy derived based on first image features based on an image captured under a first image capturing environment and a second determination accuracy derived based on second image features based on an image captured under a second image capturing environment, and detecting an attribute exhibiting an accuracy difference equal to or larger than a predetermined threshold value.

15. A control method for an image processing apparatus, comprising:
obtaining image features of a collation target person;
estimating a plurality of attributes of the collation target person based on an image of the collation target person;
obtaining a plurality of registered image features corresponding to a plurality of persons respectively associated with correct answer values of a plurality of attributes;
calculating a similarity between the image features and each of the plurality of registered image features;
determining to which of the plurality of persons the collation target person corresponds, based on the similarity calculated in the calculating; and
comparing, for each attribute, a first attribute histogram generated based on the history of the plurality of attributes estimated in the estimating and a second attribute histogram generated based on the history of the plurality of attributes corresponding to the person determined in the determining, and detecting an attribute exhibiting an accuracy difference equal to or larger than a predetermined threshold value.

16. A control method for an image processing apparatus, comprising:
obtaining image features of a collation target person;
estimating a plurality of attributes of the collation target person based on an image of the collation target person;
obtaining a plurality of registered image features corresponding to a plurality of persons respectively associated with correct answer values of a plurality of attributes;
calculating a similarity between the image features and each of the plurality of registered image features;
determining to which of the plurality of persons the collation target person corresponds, based on the similarity calculated in the calculating;
generating a first ratio distribution obtained by dividing a value of each bin of a first attribute histogram generated based on a history of a plurality of attributes estimated based on an image captured under a first image capturing environment by a value of each bin of a second attribute histogram generated based on a history of a plurality of attributes corresponding to a person determined based on image features of the image captured under the first image capturing environment;
generating a second ratio distribution obtained by dividing a value of each bin of a third attribute histogram generated based on a history of a plurality of attributes estimated based on an image captured under a second image capturing environment by a value of each bin of a fourth attribute histogram generated based on a history of a plurality of attributes corresponding to a person determined based on image features of the image captured under the second image capturing environment; and
comparing the first ratio distribution and the second ratio distribution for each attribute and detecting an attribute exhibiting an accuracy difference equal to or larger than a predetermined threshold value.

17. A non-transitory computer-readable recording medium storing a program that, when executed by a computer, causes the computer to perform a control method of an image processing apparatus, comprising:
obtaining image features of a collation target person;
obtaining a plurality of registered image features corresponding to a plurality of persons respectively associated with correct answer values of a plurality of attributes;
calculating a similarity between the image features and each of the plurality of registered image features;
determining to which of the plurality of persons the collation target person corresponds, based on the similarity calculated in the calculating;
deriving attribute-wise determination accuracy included in the plurality of attributes based on a history in which the similarity calculated in the calculating and the result of determination in the determining are associated with each other; and
comparing, for each attribute, a first determination accuracy derived based on first image features based on an image captured under a first image capturing environment and a second determination accuracy derived based on second image features based on an image captured under a second image capturing environment, and detecting an attribute exhibiting an accuracy difference equal to or larger than a predetermined threshold value.
